(19) United States
(12) Patent Application Publication
(10) Pub. No.: US 2007/0280645 A1
(43) Pub. Date: Dec. 6, 2007

(54) Operation mode control method

(75) Inventors: Toshihiro Morohoshi, Kawasaki-shi (JP); Hidehito Izawa, Hanno-shi (JP); Masahiro Takayama, Hachioji-shi (JP); Masao Iwasaki, Ome-shi (JP); Kazuhiro Takashima, Suginami-ku (JP)

Correspondence Address: PILLSBURY WINTHROP SHAW PITTMAN, LLP;Eric S. Cherry - Docketing Supervisor, P.O. BOX 10500, MCLEAN, VA, 22102, US

(73) Assignee: KABUSHIKI KAISHA TOSHIBA, Tokyo (JP)

(21) Appl. No.: 11/785,498

(22) Filed: Apr. 18, 2007

(30) Foreign Application Priority Data
Apr. 19, 2006 (JP) P2006-115613

(51) Int. Cl. H04N 5/91

(52) U.S. Cl. 386/96

(57) ABSTRACT

A method is for controlling operation mode. The method includes: activating an application for controlling a media reproduction system that reproduces at least one of audio and video files; disabling an operation mode switching function for switching a processing speed of a processor in accordance with a load of the processor while the application is activated; managing a state of the application by the application; determining an operation mode suitable for the state by the application; and controlling the media reproduction system to be performed in the operation mode by the processor.

### CROSS-REFERENCE TO RELATED APPLICATIONS

This application is based upon and claims the benefit of priority from Japanese Patent Application No. 2006-115613, filed on Apr. 19, 2006, the entire contents of which are incorporated herein by reference.

### BACKGROUND

1. Field

One embodiment of the invention relates to an operation mode control method of an apparatus incorporating a processor, such as a CPU (central processing unit). In particular, the invention relates to an operation mode control method for attaining high-speed processing and power saving in a portable device that performs various processes to audio and video data.

2. Description of the Related Art

Among conventional portable computers as electronic apparatus incorporating a CPU, there is known a configuration which allows a user to select a CPU clock frequency that relates to the operation speed of the electronic apparatus. An example of such configuration is disclosed in JP-A-5-108195 (counterpart U.S. patent application is issued as U.S. Pat. No. 5,479,645).

In thus configured portable computer, the CPU can generate the CPU clock by internally dividing the frequency of a reference clock that is externally supplied, and the CPU can be operated in one of a high-speed operation mode, a middle-speed operation mode, and a low-speed operation mode. A user can select one of these operation modes from a setup menu as well as switch between two kinds of CPU clocks that are prepared for each of the selected operation modes by a key operation

However, since a user is required to switch between the operation modes as well as between the CPU clocks for each of the operation modes, the conventional portable computer cannot accommodate an internal CPU load of which the user is not aware. Furthermore, a user cannot fully deal with a case that a CPU load variation of a very short cycle. The conventional portable computer is difficult to attain both of increase in processing speed and power saving.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is a perspective view of a audio/video processing apparatus according to a first embodiment of the present invention.

FIG. 2 schematically shows the configuration of the audio/video processing apparatus according to the first embodiment.

FIG. 3 schematically shows the configuration of a control unit according to the first embodiment.

FIG. 4 schematically shows a software configuration according to the first embodiment.

FIG. 5 is a flowchart of a process which is executed by the control unit according to the first embodiment.

FIG. 6 is a timing chart showing an operation of the control unit according to the first embodiment.

FIG. 7 is a flowchart of a process which is executed by the audio/video processing apparatus according to the first embodiment.

FIG. 8 is a flowchart of a specific state management process according to the first embodiment.

FIG. 9 is a flowchart of another specific state management process according to the first embodiment.

FIG. 10 is a flowchart of a further specific state management process according to the first embodiment.

FIG. 11 is a timing chart showing an operation of the audio/video processing apparatus according to the first embodiment.

FIG. 12 is a timing chart showing an operation of the audio/video processing apparatus according to the first embodiment at the time of video decoding.

FIG. 13 is a timing chart showing another operation of the audio/video processing apparatus according to the first embodiment at the time of video decoding.

FIG. 14 is a timing chart showing an operation of a audio/video processing apparatus according to a second embodiment of the invention.

### DETAILED DESCRIPTION

Embodiments according to the invention will be described hereinafter with reference to the accompanying drawings.

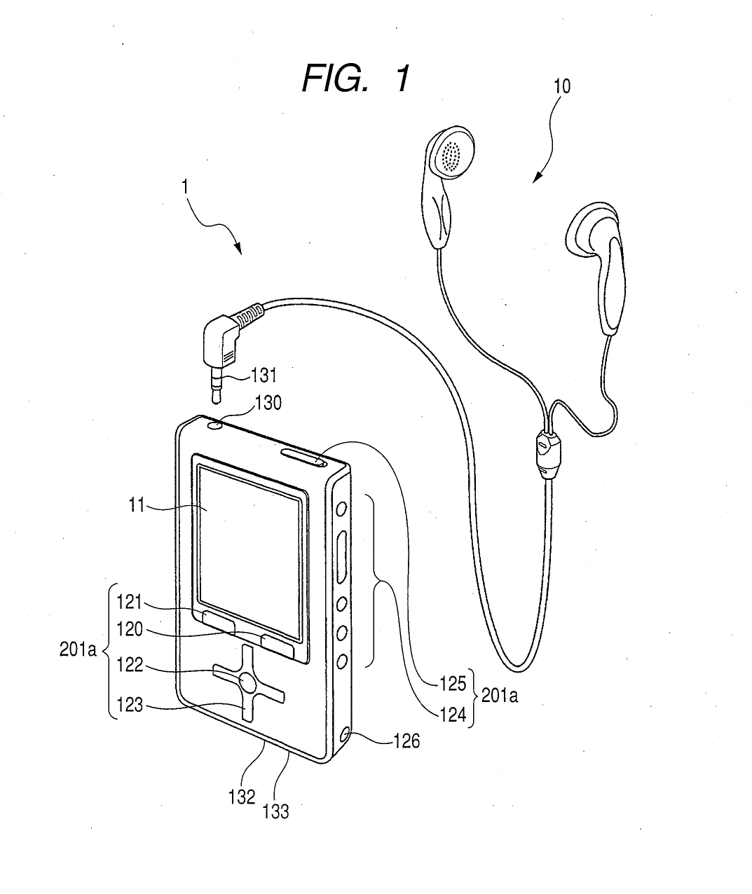

FIG. 1 is a perspective view of an audio/video processing apparatus according to a first embodiment of the invention.

The audio/video processing apparatus 1 has electronic components such as a CPU and a small-size HDD (hard disk drive) inside a case. The front face of the audio/video processing apparatus 1 is provided with a display device 11 for displaying texts and images, and a start switch 120, a back switch 121, an enter switch 122, and a four-directional arrow key 123 for selecting a displayed item. The right side face of the audio-video processing apparatus is provided with a operation switch group 124 including a power switch and a volume switch, and a power jack 126 through which an external power is supplied. The top face of the audio/video processing apparatus 1 is provided with an earphone jack 130 and a lock switch 125. The bottom face of the audio/video processing apparatus 1 is provided with a USB terminal 132 and an extension connector 133 (not shown).

An earphone 10 outputs a sound when its earphone plug 131 is inserted in the earphone jack 130.

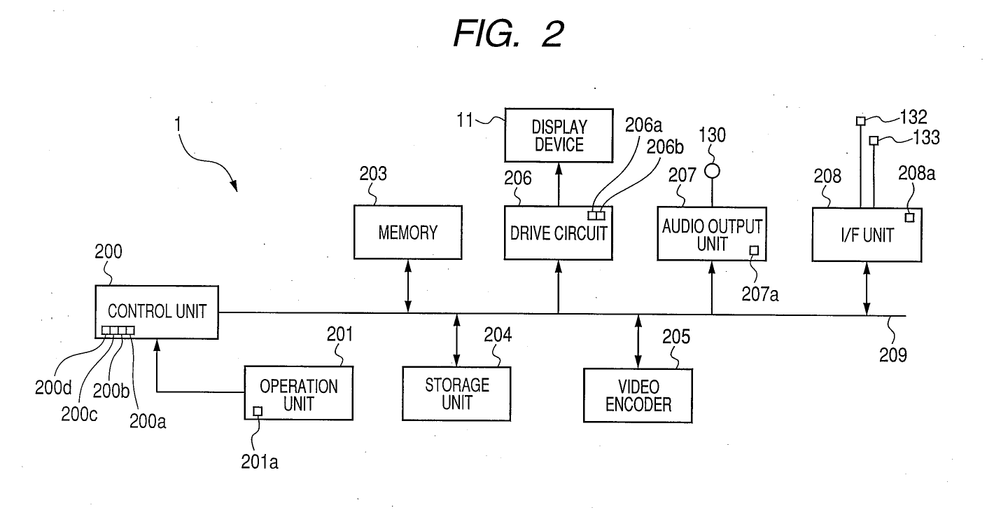

FIG. 2 schematically shows the configuration of the audio/video processing apparatus according to the first embodiment.

A control unit 200 has a CPU core 200a, a load monitor 200b, a clock interface 200c, and an external memory interface 200d. The control unit 200 controls the other components of the audio/video processing apparatus 1 to perform various operation including a clock function, file system management for audio contents and video contents, encoding and decoding process for audio and video data, setting reproduction mode, an user interface control.

An operation unit 201 outputs, to the control unit 200, an operation signal corresponding to an operation input by the user through the switches provided on the audio/video processing apparatus 1. A key pad 201a shown in FIG. 2 is a group of switches including the start switch 120, the back switch 121, the enter switch 122, and the arrow key 123 which are shown in FIG. 1.

A memory 203 temporarily stores a file containing data such as audio data, and assists data processing performed in each components.

A storage unit 204 stores firmware for operation of the audio/video processing apparatus 1, management data which are necessary for management of audio contents and other contents, application programs which are necessary for reproduction and control, setting data of programs, and content data such as audio data.

A video encoder 205v encodes an external video signal received through the extension connector 133 and stores the encoded data in the storage unit 204.

A drive circuit 206 has a backlight 206a and an LCD controller 206b, and controls the display device 11 in accordance with data input through a bus 209 from the control unit 200, and displays an image in response to a user operation on the display device 11.

An audio output unit 207 has an audio codec 207a, and amplifies a decoded audio signal with a built-in amplifier and outputs the decoded signal to the earphone jack 130.

An interface unit 208 has the extension connector 133 and the USB terminal 132, and controls input/output of content data to and from the bus 209 when an external apparatus is connected to the USB terminal 132.

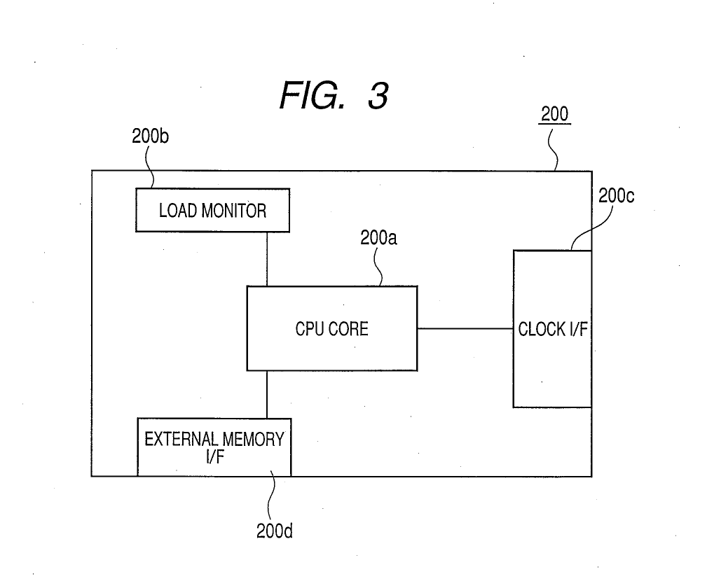

FIG. 3 schematically shows the configuration of the control unit according to the first embodiment.

The control unit 200 has the CPU core 200a that performs computation, the load monitor 200b that monitors the load state of the CPU core 200a, the clock interface 200c that serves as an interface with an external an operation clock and controls the clock speed and voltage, and the external memory interface 200d that serves as an interface for a communication with an external memory and controls the clock speed and voltage. The components 200b-200c are connected to the CPU core 200a, which is a core component.

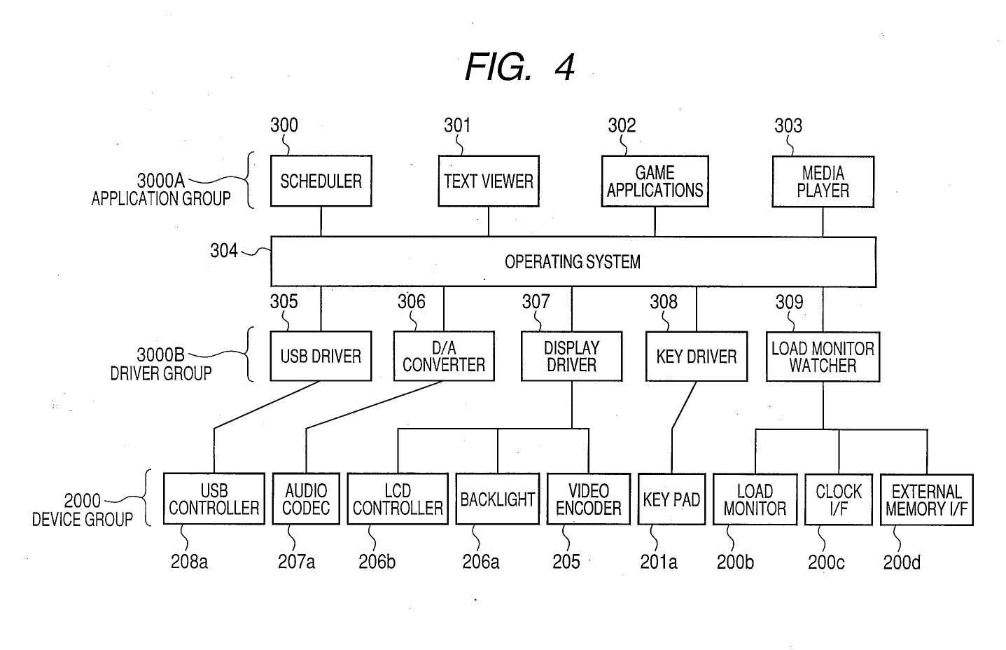

FIG. 4 schematically shows a software configuration according to the first embodiment.

The software includes an application group 3000A, an operating system 304, and a driver group 3000B. A device group 2000 is provided for drivers of the driver group 3000B.

The application group 3000A includes a scheduler 300 that has a calendar function and performs schedule management, a text viewer 301 that enables viewing of a text file, game applications 302 that performs various games, and a media player 303 that reproduce and record an audio file and a video file.

The operating system 304 manages the application group 3000A and the driver group 3000B in a unified manner.

The driver group 3000B includes: a USB driver 305 that controls a USB controller 108a; a D/A converter 306 that converts audio data into an audio signal by cooperating with the audio codec 207a; a display driver 307 that manages and controls the backlight 206a, the LCD controller 206b, and the video encoder 205; a key driver 308 that controls an input signal from the keypad 201a; and a load monitor watcher 309 that manages and controls the load monitor 200b, the clock interface 200c, and the external memory interface 200d of the control unit 200.

The operation of the audio/video processing apparatus 1 according to the first embodiment will be described below with reference to FIGS. 1-13.

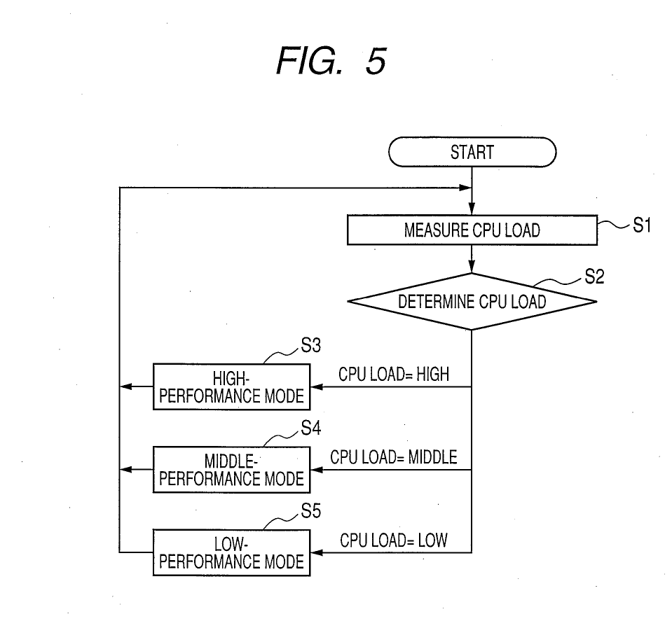

FIG. 5 is a flowchart of a process that is executed by the control unit 200 according to the first embodiment.

When the audio/video processing apparatus 1 is powered on, the control unit 200 starts operating. First, at step S1, the load monitor 200b measures a load (CPU load) of the CPU core 200a. At step S2, the load monitor watcher 309 determines a performance mode on the basis of the measured CPU load.

If the CPU load is high, to let the control unit 200 operate in a high-performance mode, at step S3 the load monitor watcher 309 causes the load monitor 200b to instruct, via the CPU core 200a, the clock interface 200c and the external memory interface 200d to operate at a clock speed and a voltage of the high-performance mode.

If the CPU load is in a middle range, to let the control unit 200 operate in a middle-performance mode, at step S4 the load monitor watcher 309 causes the load monitor 200b to instruct, via the CPU core 200a, the clock interface 200c and the external memory interface 200d to operate at a clock speed and a voltage of the middle-performance mode.

If the CPU load is low, to let the control unit 200 operate in a low-performance mode, at step S5 the load monitor watcher 309 causes the load monitor 200b to instruct, via the CPU core 200a, the clock interface 200c and the external memory interface 200d to operate at a clock speed and a voltage of the low-performance mode.

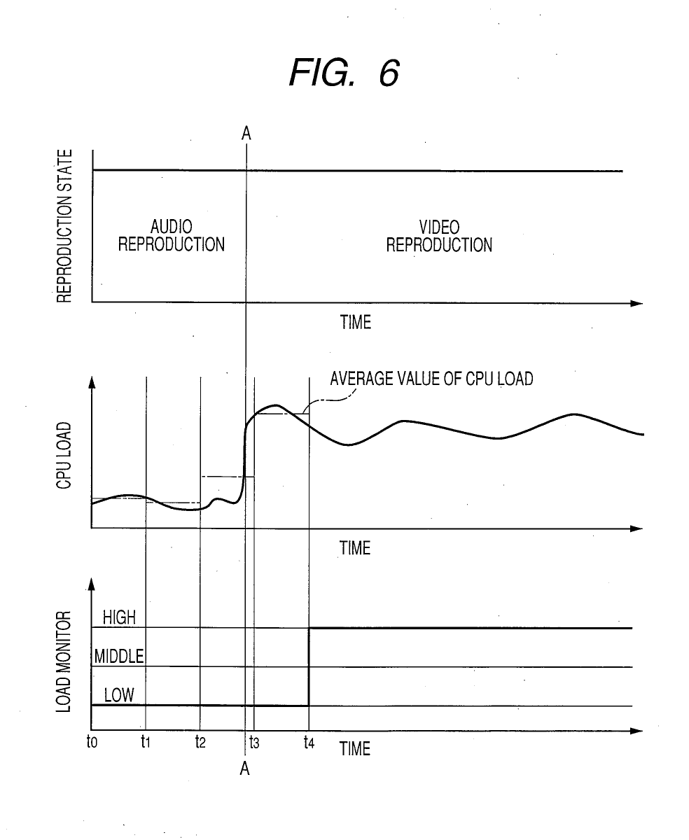

FIG. 6 is a timing chart showing an operation of the control unit according to the first embodiment.

Where audio reproduction is started at time t0 and video reproduction is started at time A, the CPU load rises at time A because the load on the control unit 200 is higher in video reproduction than in audio reproduction. The load monitor 200b measures an average value of a varying CPU load at predetermined intervals of 10 ms. If an average value is larger than a predetermined threshold value, the load monitor watcher 309 switches performance modes.

In periods t0-t1, t1-t2, and t2-t3, CPU load average values are not larger than the threshold value for the low-performance mode and hence the load monitor watcher 309 causes the control unit 200 to operate in the low-performance mode. In a period t3-t4, since a CPU load average value is larger than the threshold value for the high-performance mode, the load monitor watcher 309 causes the control unit 200 to operate in the high-performance mode from time t4. This causes a delay time of (t4-A).

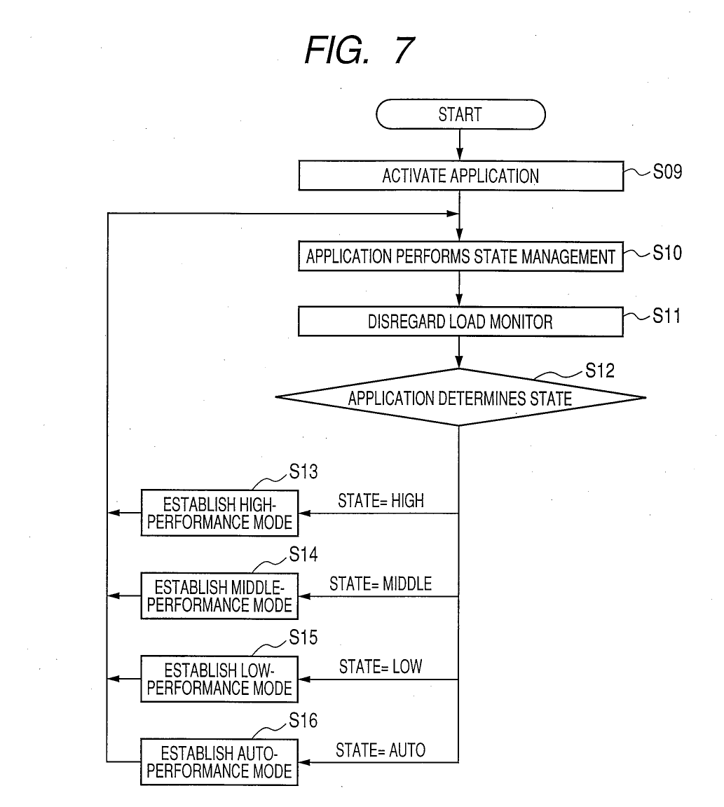

FIG. 7 is a flowchart of a process which is executed by the audio/video processing apparatus according to the first embodiment.

When the audio/video processing apparatus 1 is powered on, the control unit 200 starts operating. At step S9, one application of the application group 3000A is activated. For example, while the media player 303 is being run, at step S10 the media player 303 performs state management for detecting a state and an operation that require the control unit 200 to follow the processing of the media player 303 when such a state and an operation occur. At step S11, the media player 303 sends a command to the load monitor watcher 309 via the operating system 304 and thereby instructs the load monitor watcher 309 to disregard information that will be sent from the load monitor 200b.

At step S12, the media player 303 determining one of the predetermined performance modes on the basis of the above state and operation and informs the load monitor watcher 309 of the determined performance mode via the operating system 304.

If the media player 303 determines that the CPU load is high, to let the control unit 200 operate in the high-performance mode, at step S13 the load monitor watcher 309 causes the load monitor 200b to instruct, via the CPU core 200a, the clock interface 200c and the external memory interface 200d to operate at a clock speed and a voltage of the high-performance mode.

If the media player 303 determines that the CPU load is in a standard (middle) range, to let the control unit 200 operate in the middle-performance mode, at step S14 the load monitor watcher 309 causes the load monitor 200b to instruct, via the CPU core 200a, the clock interface 200c and the external memory interface 200d to operate at a clock speed and a voltage of the middle-performance mode.

If the media player 303 determines that the CPU load is low, to let the control unit 200 operate in the low-performance mode, at step S15 the load monitor watcher 309 causes the load monitor 200b to instruct, via the CPU core 200a, the clock interface 200c and the external memory interface 200d to operate at a clock speed and a voltage of the low-performance mode.

If the media player 303 determines that the CPU load is such that the control unit 200 will follow it well when an auto-performance mode is established, at step S16 the media player 303 sends, to the load monitor watcher 309, a command to instruct it not to disregard the load monitor 200b. Then, the control unit 200 operates according to the flowchart of FIG. 5.

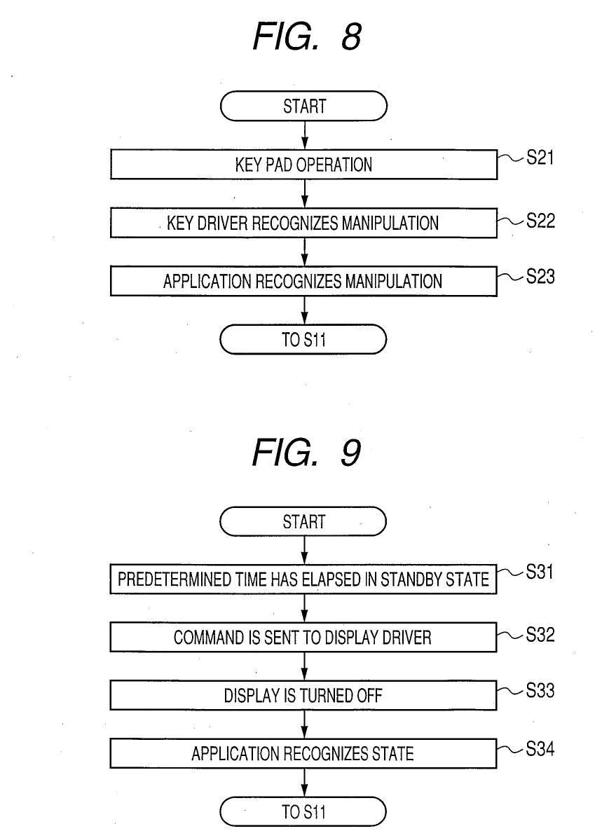

The following descriptions which will be made with reference to FIGS. 8-10 correspond to step S10 in FIG. 7.

FIG. 8 is a flowchart of a specific state management process according to the first embodiment.

For example, the key pad 201a is operated to operate the text viewer 301 at step S21. At step S22, the operation on the key pad 201a is recognized by the key driver 308. At step S23, the key driver 308 sends operation information to the text viewer 301 via the operating system 304, whereby the text viewer 301 recognizes the operation. Then, the process moves to step S11 in FIG. 7, where the text viewer 301 instructs the load monitor watcher 309 to disregard information that will be sent from the load monitor 200b. For example, when the key pad 201a is operated so as to scroll a text frequently, the load of the control unit 200 is high and hence the control unit 200 is caused to operate in the high-performance mode.

FIG. 9 is a flowchart of another specific state management process according to the first embodiment.

For example, if a predetermined time has elapsed with no operation performed on the key pad 201a in a state that the scheduler 300 is in operation (S31), at step S32 the scheduler 300 sends a command to the display driver 307. At step S33, the display driver 307 turns off the display of the display device 11 by letting the backlight 206a, the LCD controller 206b, and the video encoder 205 stop operating. At step S34, the display driver 307 sends a command to the scheduler 300, whereby the scheduler 300 recognizes a state. Then, the process moves to step S11 in FIG. 7, where the scheduler 300 instructs the load monitor watcher 309 to disregard information that will be sent from the load monitor 200b. When the load that has been imposed on the control unit 200 to drive the display device 11 has disappeared in a state that a standby load of the control unit 200 is low as with the scheduler 300, the control unit 200 is caused to operate in the low-performance mode.

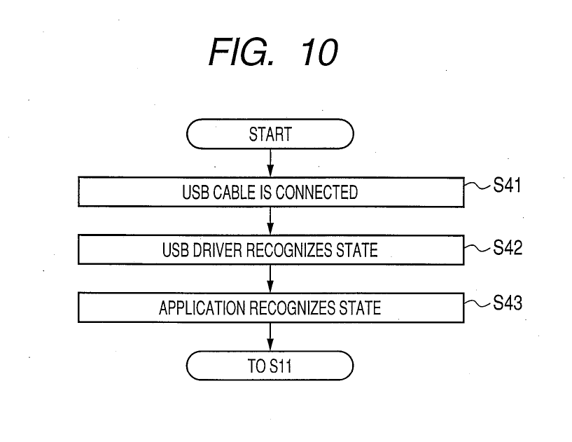

FIG. 10 is a flowchart of a further specific state management process according to the first embodiment.

For example, when the audio/video processing apparatus 1 communicates with an external computer by inserting a USB cable (not shown) into the USB terminal 132 (S41), at step S42 the USB driver 305 recognizes a state of the USB controller 208a. At step S43, the USB driver 305 sends a command to a game application 302, for example, whereby the game application 302 recognizes the state. Then, the process moves to step S11 in FIG. 7, where the game application 302 instructs the load monitor watcher 309 to disregard information that will be sent from the load monitor 200b. A communication with an external computer imposes a high load on the controller 200 and power is supplied via a USB cable. In such a situation, the control unit 200 is always caused to operate in the high-performance mode.

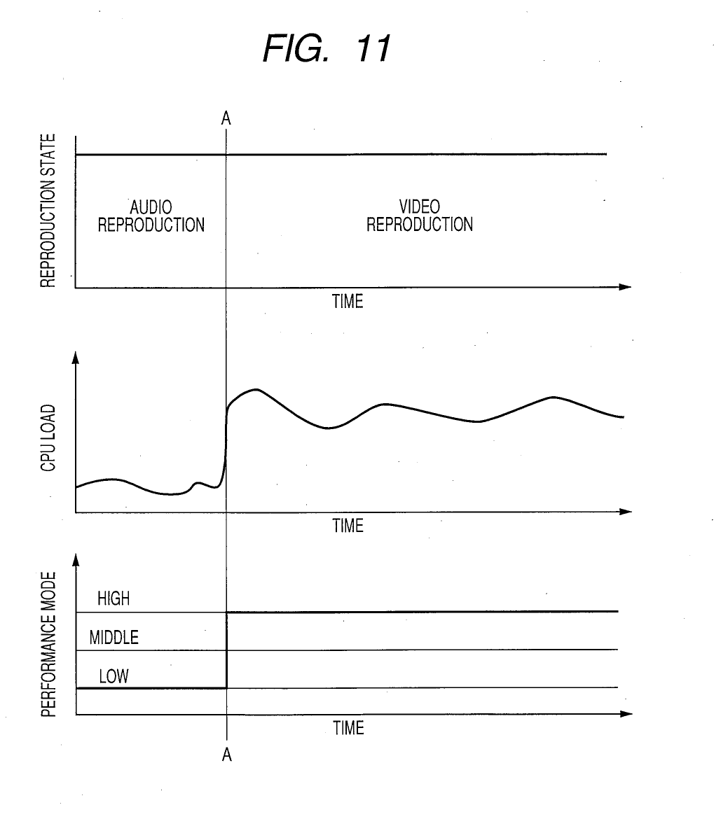

FIG. 11 is a timing chart showing an operation of the audio/video processing apparatus according to the first embodiment.

Video reproduction is started at time A in a state that audio is being reproduced, and the CPU load rises at time A because the load on the control unit 200 is higher in video reproduction than in audio reproduction. The media player 303 determines the switching from the audio reproduction to the video reproduction as a state variation (this is done inside the application). The performance mode of the controller 200 is switched from the low-performance mode to the high-performance mode at time A in response to an instruction from the application, and the control unit 200 is thereby caused to follow the CPU load variation.

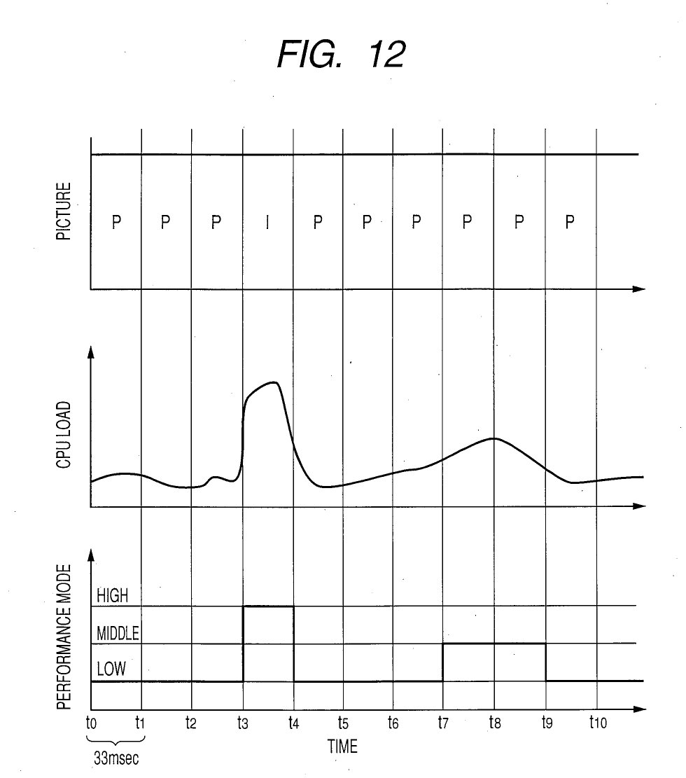

FIG. 12 is a timing chart showing an operation of the audio/video processing apparatus according to the first embodiment at the time of video decoding.

In general, a moving image file of the MPEG (Moving Picture Experts Group) standard consists of I-pictures (intra-frames) and P-pictures (inter-frames) each of which is differences from an I-picture or a P-picture ensuing it (see FIG. 12). Each picture lasts 33 ms.

An I-picture occurring from t3 to t4 causes a high CPU load because an image should be drawn as a whole, and ensuing P-pictures (differences) generally cause a light CPU load. However, the CPU load increases when a P-picture having large differences such as ones occurring from t7 to t9 is processed.

Timing for processing an I-picture and timing for processing a P-picture having large differences can be judged by reading a header with a decoder for processing an MPEG file. Therefore, the performance mode can be changed so as to follow a CPU load variation by the media player 303's sending a command to the load monitor watcher 309 with such timing.

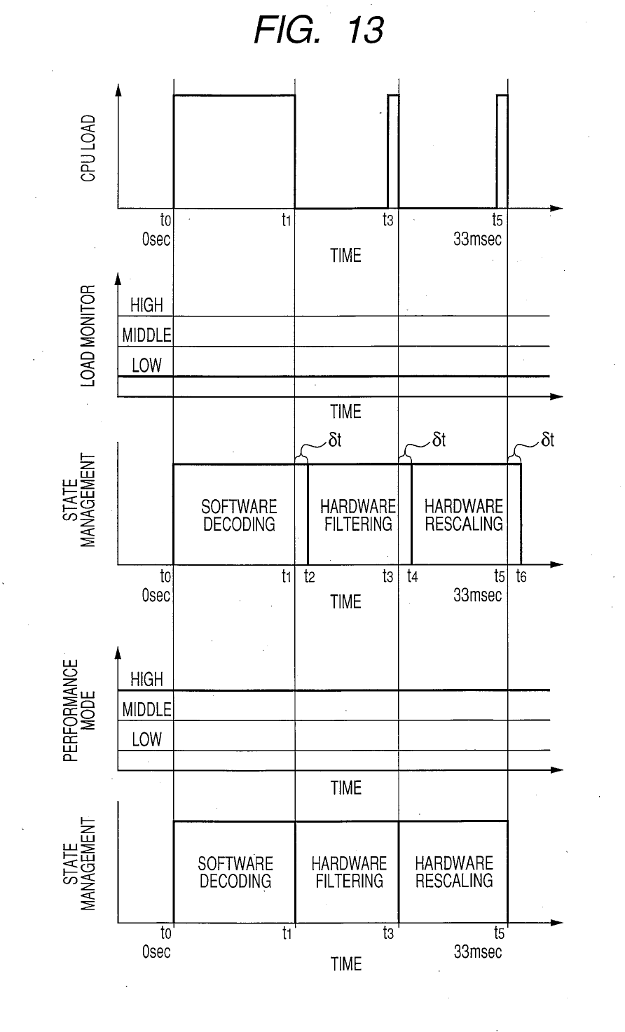

FIG. 13 is a timing chart showing another operation of the audio/video processing apparatus according to the first embodiment at the time of video decoding.

In general, an MPEG file is processed in such a manner that it is decoded by software such as the media player 303 and then subjected to filtering and resealing by hardware such as the drive circuit 206.

In a period t0-t1, decoding is performed by software and hence the CPU load is high. In a period from t1-t3, the CPU load is low because hardware filtering is performed though the CPU load increases temporarily during a data transfer between pieces of hardware which is performed after the filtering. In a period from t3-t5, the CPU load is low because hardware resealing is performed though the CPU load increases temporarily during a data transfer between pieces of hardware which is performed after the resealing. This series of operations lasts 33 ms (one frame).

The load monitor 200b measures an average value of a varying CPU load in a predetermined period. Therefore, the load monitor 200b determines that the low-performance mode should be established on the basis of the CPU load variation of the one frame. When the control unit 200 operates in the low-performance mode according to an instruction from the load monitor 200b, the control unit 200 cannot finish the software decoding by time t1 and finishes it at time t2 which is □t after time t1. Since the hardware filtering end time and the hardware scaling end time are also delayed by □t, the processing of the one frame is not completed in 33 ms and display of a moving image suffers a frame loss.

In contrast, where the control unit 200 is managed by the media player 303, the load monitor watcher 309 issues an instruction to cause the control unit 200 to operate in the high-performance mode. Therefore, no delay occurs in the software decoding and the processing is completed in 33 ms.

In the above-described embodiment, the application level can control the performance mode of the control unit 200 via the load monitor watcher 309 while disregarding the load monitor 200b. This makes it possible to select a performance mode that allow the control unit 200 to follow a CPU load variation reliably, which in turn makes it possible to attain increase in processing speed and power saving.

Since the application level controls the performance mode of the control unit 200, the first embodiment can cope with a load variation of internal processing which a user cannot recognize, which also contributes to increase in processing speed and power saving.

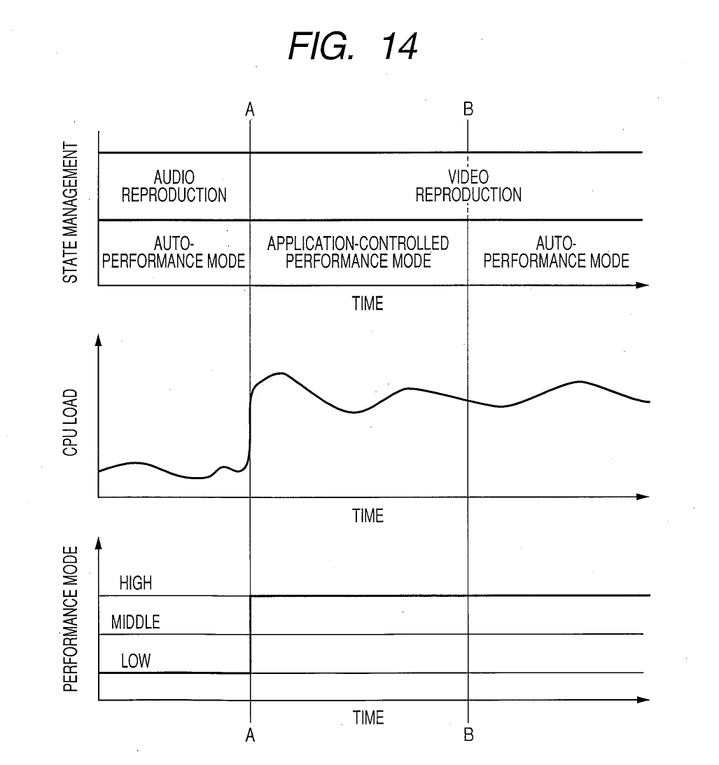

The operation of a audio/video processing apparatus according to a second embodiment will be described below with reference to FIG. 14 and other drawings.

FIG. 14 is a timing chart showing an operation of the audio/video processing apparatus according to the second embodiment. In the following description, components that are the same in configuration and function as corresponding components of the first embodiment will be given the same reference symbols as the latter.

Video reproduction is started at time A in a state that audio is being reproduced, and the CPU load rises at time A because the load on the control unit 200 is higher in video reproduction than in audio reproduction. Until time A, the control unit 200 is caused to operate in the auto-performance mode which is based on the CPU load measurement by the load monitor 200b. At time A, the media player 303 determines the switching from the audio reproduction to the video reproduction as a state variation (this is done inside the application). The performance mode of the controller 200 is switched from the low-performance mode to the high-performance mode, and the control unit 200 is thereby caused to follow the CPU load variation. At time B, the control unit 200 is caused to operate in the auto-performance mode again.

In the above-described embodiment, timing of a rapid increase in the load on the control unit 200 such as switching between reproduction states is detected as a state variation (this is done inside the application). And the load monitor 200b makes determinations for other kinds of states and state variations. This makes it possible to more flexibly cope with a variation in the load of the control unit 200, which in turn makes it possible to attain increase in processing speed and power saving.

The interval between time A and B may be set either by a designer or a user of the audio/video processing apparatus 1, and may be adjusted in consideration of balance between the increase in processing speed and the power saving.

According to the present invention, there is provided an operation mode control method that allows the CPU operation mode to follow a CPU load variation and hence can attain both of increase in processing speed and power saving.

The present invention is not limited to any one of the aforementioned embodiments. Various modifications or changes can be made on the invention without departing from the gist thereof when it is carried out. The embodiments may be combined with one another suitably if possible, or each embodiment may be partially deleted when it is carried out. On those occasions, various effects caused by the combination or deletion can be obtained.

It is to be understood that the invention is not limited to the specific embodiments described above and that the invention can be embodied with the components modified without departing from the spirit and scope of the invention. The invention can be embodied in various forms according to appropriate combinations of the components disclosed in the embodiment described above. For example, some components may be deleted from all components shown in the embodiment. Further, the components in different embodiments may be used appropriately in combination.

What is claimed is:

1. A method for controlling operation mode comprising:
activating an application for controlling a media reproduction system that reproduces at least one of audio and video files;
disabling an operation mode switching function for switching a processing speed of a processor in accordance with a load of the processor while the application is activated;
managing a state of the application by the application;
determining an operation mode suitable for the state by the application; and
controlling the media reproduction system to be performed in the operation mode by the processor.

2. The method according to claim 1, wherein the state is managed by a process comprising:
recognizing an operation input through a key pad by a key driver; and
managing the state by the application in accordance with a command received from the key driver, the command indicating the recognized operation.

3. The method according to claim 1, wherein the state is managed by a process comprising:
sending a command from the application to a display driver when no operation signal is input for a predetermined time period;
turning off display of a display device by the display driver when the command is received; and
recognizing a signal received by the application from the display driver, the signal being based on an operation of the display driver.

4. The method according to claim 1, wherein the state is managed by a process comprising:
recognizing a connection with an external computer by a USB driver when an apparatus incorporating the processor is connected to the external computer via a USB terminal; and
recognizing the connection with the external computer by the application when a command is received from the USB driver, the command notifying the connection with the external computer.

5. The method according to claim 1, further comprising:
enabling the operation mode switching function when determined that the operation mode switching function should be enabled.

6. The method according to claim 1, wherein the operation mode is configurable by combination of: a plurality of processor clock speeds; a plurality of processor operation voltages; a plurality of bus clock speeds; and a plurality of bus operation voltages.

7. A method for controlling operation mode comprising:
activating an application for controlling a media reproduction system that reproduces at least one of audio and video files;
controlling an operation of a processor through an operation mode switching function for switching a processing speed of the processor in accordance with a load of the processor while the application is activated;
disabling the operation mode switching function when a state of the application is rapidly changed;
managing the state of the application by the application;
determining an operation mode suitable for the state by the application;
controlling the media reproduction system to be performed in the operation mode by the processor; and
enabling the operation mode switching function when a predetermined time period is lapsed after start controlling the media reproduction system to be performed in the operation mode.

8. The method according to claim 7, wherein the operation mode is configurable by combination of: a plurality of processor clock speeds; a plurality of processor operation voltages; a plurality of bus clock speeds; and a plurality of bus operation voltages.
